(19) United States
(12) Patent Application Publication
(10) Pub. No.: US 2005/0240537 A1
(43) Pub. Date: Oct. 27, 2005

(54) Transaction Oriented Promotion Conflict Resolution

(75) Inventor: Chang Li, Toronto, Ontario (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 10/907,141

(22) Filed: Mar. 22, 2005

(30) Foreign Application Priority Data
Apr. 22, 2004 (CA) 2464860

(51) Int. Cl. G06F 17/60

(52) U.S. Cl. 705/80; 705/16

(57) ABSTRACT

There is provided, in one embodiment, a computer implemented method, for providing transaction oriented conflict resolution for an electronic commerce application. The computer implemented method comprising obtaining one or more promotions each having at least one associated policy and creating a context object containing a plurality of objects indicative of an initial state of the system at the time the transaction began. Next is created a control object containing clones of the plurality of objects contained within the context object. Application of the one or more promotions is then made to the created control object. Afterward there is a check for violation of the at least one policy associated with the respective one or more promotions and where no violation has been found then committing the promotion. If a violation was found then the system would be rolled back to a state indicated by the context object and the transaction would end.

### FIELD OF THE INVENTION

This present invention relates generally to conflict resolution and more specifically to promotion conflict resolution using a transaction oriented technique in electronic commerce environments.

### BACKGROUND OF THE INVENTION

Promotion may be defined as a shopping related incentive offered to general or specific customers in order to entice them to make purchases in a store. The promotions, representing the incentives, may be realized through or in conjunction with different marketing reward programs such as price or service discounts, free gifts, coupon, or bonus points in a loyalty program. Promotions play an increasingly more important role in modern retailing. As a result, at any given time, there are usually a large number of promotions in effect in a commerce system. The applicability and combinations of these various promotions is also becoming more and more complex. The process to determine applicability and combinations of various promotions is often referred to as a conflict resolution process in a commerce system. This process is used to determine, in situations where more than one promotion is applicable at the same time, which one or more than one should be applied and in what order, and which ones should not. This problem is further complicated by the situation where most merchants' operating systems that offer promotions to their clients have very different ways of determining the applicability and combinations of promotions. Most commercial systems either provide very little help to address this problem or implement a fixed way of support. Modifying or extending such a system to incorporate any new or slightly different conflict resolution logic is usually a very difficult task.

Previous instances of using promotions in commerce systems have had a scattered focus that has produced a wide variation in results. In some cases the promotion was non-discriminatory and was displayed to any casual user who happened by the display device. In another example a simple aggregation of a promotion was performed on a single site without mention of any explanation of how to evaluate applicability of the promotion to specific user. Other means of linking a coupon code to a history of purchases retained in a storage means have been tried as well. Capture and use of such history information has been then used previously to determine advertising presentation but not to address determination of promotion allocation. In still another situation much emphasis has been placed on the shopper history or profile without any means of further determining promotions or discounts. Some cases have also dealt with conflict resolution but those have been limited to the area of storage allocation techniques.

Conflict resolution is therefore very important part of any promotion system. Conflict resolution can be used to detect if any business policies are violated by application of a particular promotion. This conflict resolution process may be a complex process. In the process, multiple policies need to be tested to determine if any policies are violated. In order to determine whether a violation will arise by applying a promotion, the policies need to determine the types of changes caused by applying the promotion to the system, i.e. the “after state”. However, if the changes are made directly to the system, problems may occur when one or more policies determine a violation would have occurred if this promotion were applied. When that such a determination is made, the promotion is eliminated and the “before state” of the system needs to be restored. That may not always possible if the state of the system has been changed permanently. An alternative would be to let an individual policy determine what the effect of applying a promotion is by combining the “before state” of the system with the changes introduced by way of applying a promotion. This process would then become part of a policy's conflict detection logic. The disadvantage of this approach is that it would elevate the complexity of promotion policies.

It would therefore be highly desirable to have a capability of reducing the complexity of promotion policies and having a more efficient conflict resolution mechanism.

### SUMMARY OF THE INVENTION

Conveniently, software exemplary of an embodiment of the present invention provides a capability for promotion policies to detect conflicts given a state of the system, and how to compute the effects on the system of applying a promotion. In addition, the implementation of policies may also be capable of combining the state of the system with the projected impact from applying a promotion so that the “before state” of the system is preserved and “after state” can be computed.

Inspired by the transaction model in RDBMS (Relational Database Management System), a technique was devised mimicking a database transaction concept for use in the context of a promotion conflict resolution. As a result, the technique is not only able to preserve the “before state” of the system, but also able to alleviate individual policies from the task of computing the “after state”, all with reasonable efficiency.

Using the analogy from RDBMS, the process of conflict detection is viewed as a single transaction. The effect of applying a promotion is computed within the context of the transaction, the application of each individual policy is performed within the same transaction after the promotion is tentatively applied. If application of any policy should report a violation, the transaction is deemed to have failed, and all its changes will be rolled back. If no application of policies report any violation, the transaction is deemed successful, and the changes will be committed. That is the promotion will be applied and the “after state” will become the new “before state”.

This technique may make it possible for the system to preserve the “before state” and at the same time compute the “after state” once for all policies. Application of policies are spared the task of computing the after state themselves and are simplified to a point where all they need to do is to report any violations given a state of the system.

In one embodiment of the present invention there is provided a computer implemented method for providing transaction oriented conflict resolution for an electronic commerce application, the computer implemented method comprising: obtaining one or more promotions each having at least one associated policy; creating a context object containing a plurality of objects indicative of an initial state; creating a control object containing clones of the plurality of objects contained within the context object; applying the one or more promotions to the control object; checking for violation of the at least one policy associated with the respective one or more promotions and where none is found committing the promotion; otherwise rolling back to a state indicated by the context object and ending the transaction.

In another embodiment of the present invention there is provided a computer system for providing transaction oriented conflict resolution for an electronic commerce application, the computer system comprising: means for obtaining one or more promotions each having at least one associated policy; means for creating a context object containing a plurality of objects indicative of an initial state; means for creating a control object containing clones of the plurality of objects contained within the context object; means for applying the one or more promotions to the control object; means for checking for violation of the at least one policy associated with the respective one or more promotions and where none is found committing the promotion; otherwise rolling back to a state indicated by the context object and ending the transaction.

In yet another embodiment of the present invention there is provided an article of manufacture for directing a data processing system to provide transaction oriented conflict resolution for an electronic commerce application, the article of manufacture comprising: a computer usable medium embodying one or more instructions executable by the data processing system, the one or more instructions comprising: data processing system executable instructions for obtaining one or more promotions each having at least one associated policy; data processing system executable instructions for creating a context object containing a plurality of objects indicative of an initial state; data processing system executable instructions for creating a control object containing clones of the plurality of objects contained within the context object; data processing system executable instructions for applying the one or more promotions to the control object; data processing system executable instructions for checking for violation of the at least one policy associated with the respective one or more promotions and where none is found committing the promotion; otherwise rolling back to a state indicated by the context object and ending the transaction.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate embodiments of the present invention by example only,

FIG. 1 is a block diagram of a system in which an embodiment of the invention may be implemented;

FIG. 2a is a block diagram showing example relationships between policies and promotions of an embodiment of the invention of FIG. 1;

FIG. 2b is a tabular view of sample of a promotion execution agenda of promotion and policy relationships of FIG. 2;

FIG. 3 is a block diagram of classes in support of the sample table of FIG. 2;

FIG. 4 is a flowchart showing an example of an evaluation process of an embodiment of the invention of FIG. 1;

FIG. 5 is a flowchart showing an example of a variant of the promotion evaluation process of FIG. 4.

Like reference numerals refer to corresponding components and steps throughout the drawings.

### DETAILED DESCRIPTION

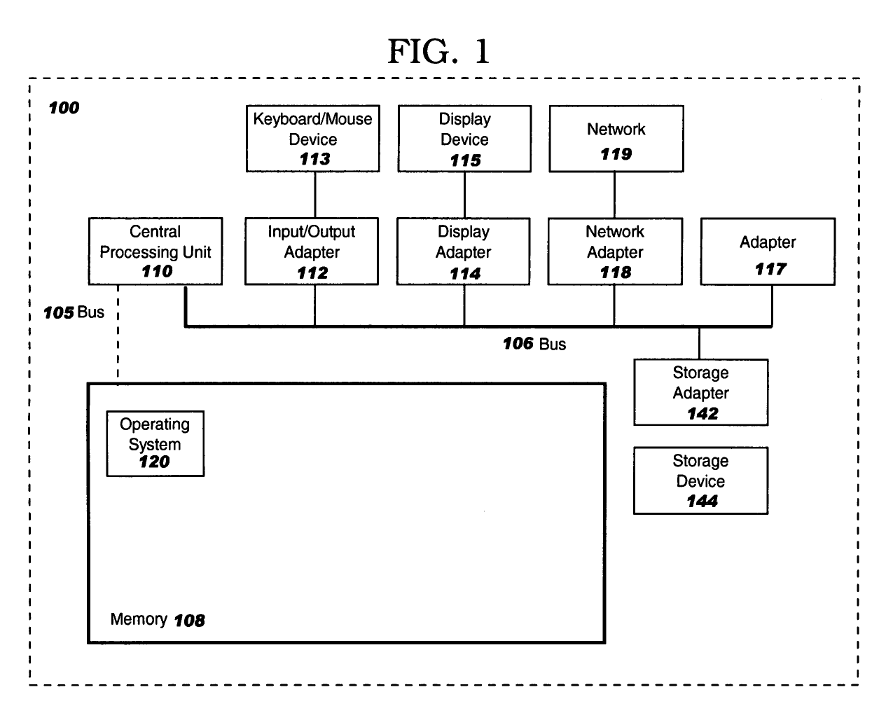

FIG. 1 depicts, in a simplified block diagram, a computer system 100 suitable for implementing embodiments of the present invention. Computer system 100 has a central processing unit (CPU) 110, which is a programmable processor for executing programmed instructions stored in memory 108. Memory 108 can also include hard disk, tape or other storage media. While a single CPU is depicted in FIG. 1, it is understood that other forms of computer systems can be used to implement the invention, including multiple CPUs. It is also appreciated that the present invention can be implemented in a distributed computing environment having a plurality of computers communicating via a suitable network 119, such as the Internet.

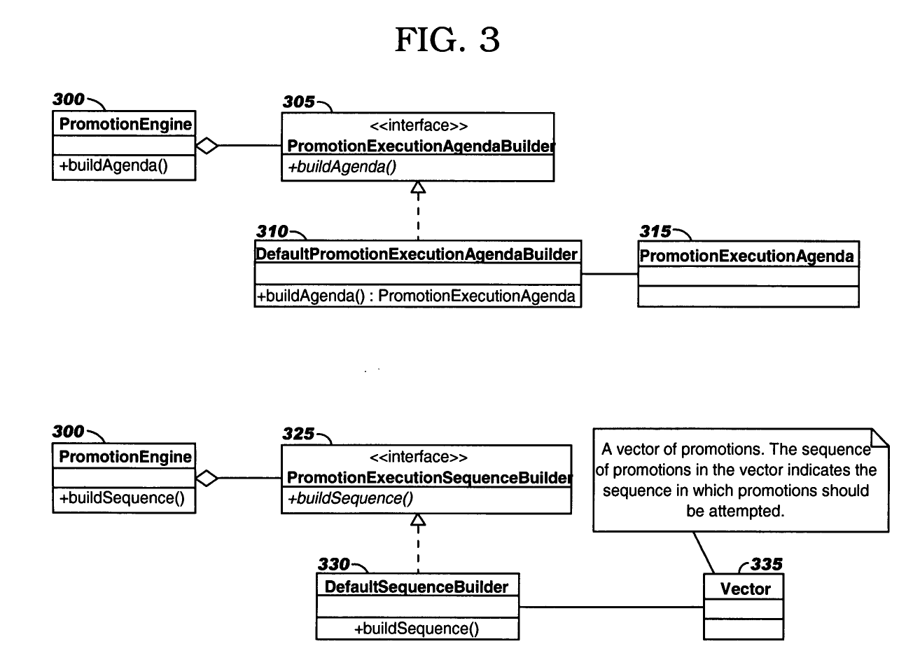

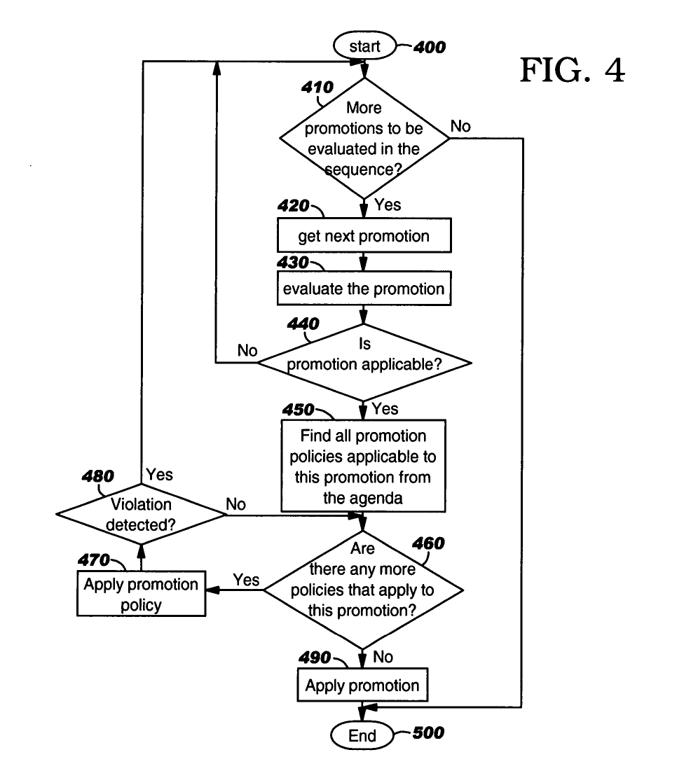

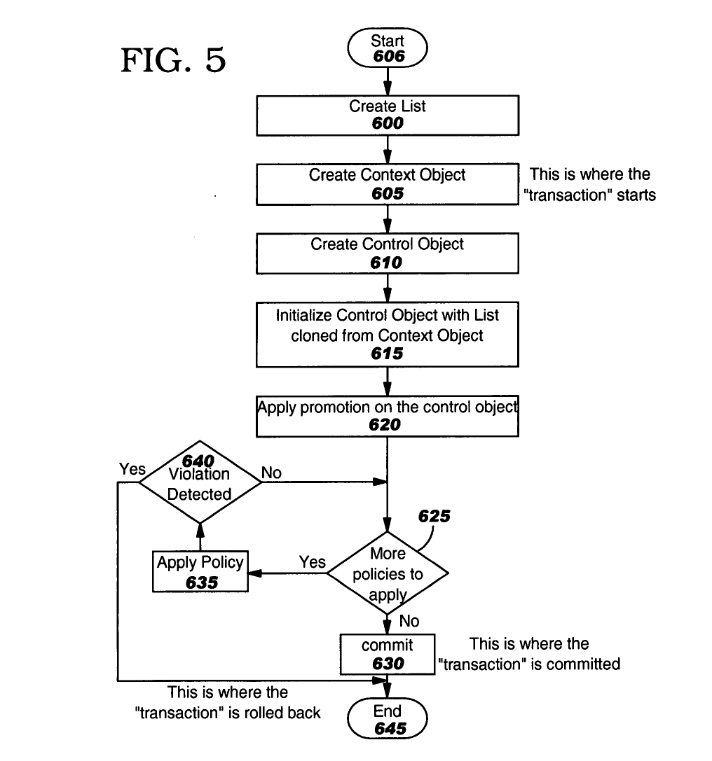

CPU 110 is connected to memory 108 either through a dedicated system bus 105 and/or a general system bus 106. Memory 108 can be a random access semiconductor memory for containing components such as table 315, code to implement elements of FIG. 3 and the processes of FIGS. 4 and 5. Similarly such components may also reside on storage device 144 until required for use. Memory 108 is depicted conceptually as a single monolithic entity but it is well known that memory 108 can be arranged in a hierarchy of caches and other memory devices. FIG. 1 illustrates that operating system 120, may reside in memory 108.

Operating system 120 provides functions such as device interfaces, memory management, multiple task management, and the like as known in the art. CPU 110 can be suitably programmed to read, load, and execute instructions of operating system 120, build components of FIG. 3, and load table 315. Computer system 100 has the necessary subsystems and functional components to implement transaction oriented conflict resolution as will be discussed later. Other programs (not shown) include server software applications in which network adapter 118 interacts with the server software application to enable computer system 100 to function as a network server via network 119.

General system bus 106 supports transfer of data, commands, and other information between various subsystems of computer system 100. While shown in simplified form as a single bus, bus 106 can be structured as multiple buses arranged in hierarchical form. Display adapter 114 supports video display device 115, which is a cathode-ray tube display or a display based upon other suitable display technology that may be used to depict data. The Input/output adapter 112 supports devices suited for input and output, such as keyboard or mouse device 113, and a disk drive unit (not shown). Storage adapter 142 supports one or more data storage devices 144, which could include a magnetic hard disk drive or CD-ROM drive although other types of data storage devices can be used, including removable media for storing components such as relationship table 315, and other objects from the build operations of FIG. 3, such as sequence vector 335.

Adapter 117 is used for operationally connecting many types of peripheral computing devices to computer system 100 via bus 106, such as printers, bus adapters, and other computers using one or more protocols including Token Ring, LAN connections, as known in the art. Network adapter 118 provides a physical interface to a suitable network 119, such as the Internet. Network adapter 118 includes a modem that can be connected to a telephone line for accessing network 119. Computer system 100 can be connected to another network server via a local area network using an appropriate network protocol and the network server can in turn be connected to the Internet. FIG. 1 is intended as an exemplary representation of computer system 100 by which embodiments of the present invention can be implemented. It is understood that in other computer systems, many variations in system configuration are possible in addition to those mentioned here.

The fundamental problem to be resolved is to find an efficient way to determine if one or more of the applicable promotions from a plurality of promotions are all deemed to be suitable. In attempting to resolve this problem a transaction oriented approach is used to first “test” the application of a promotion and then only if acceptable, commit the resulting changes, thereby safeguarding the system from undesired changes. The transaction oriented technique begins with defining the possible changes the application of a promotion can have on the system, as well as any side effects of applying a promotion's policies. Currently, a list of possible effects may include the following (this list is not meant to be exhaustive and typically grows with use as the system is being improved) when a promotion is applied:
a certain product may no longer be eligible for other promotions
certain monetary values may be changed as a result. For example, the price of an item may be discounted by 20%, or it may be shipped for free
certain other promotions may no longer be applied

The process of promotion conflict resolution can be described as a 3 step process: 1) Determining applicable promotions from a plurality of potentially applicable promotions, and at the same time determining if these selected promotions are subject to any business policies and applying those policies in the form of conflict resolution; 2) Determining the sequence in which the applicability of the promotions selected in the first step should be tested; and 3) In the situation of one or more promotions being applicable, determining if by applying these promotions a conflict situation would arise.

To fulfil the tasks above, the system organizes promotions into promotion groups and associating promotions with promotion policies that are applicable to them by means of creating a relationship table. It also uses object technology to externalize the process of determining the list of promotions that should be attempted, as well as in which sequence they should be attempted and creates a simple sequence vector of desired promotions. The system also defines a standard interface for business policies so that any additional policies can be added easily into the system. The end result of these efforts is a process that is more flexible and much easier to be extended than a traditional conflict resolution process.

Terminology used in this section: includes the following terms:

Promotion: a marketing/merchandising incentive which has conditions that need to be satisfied and offers rewards such as discounts and/or gifts.

Promotion Group: a mechanism to organize promotions in to clusters. Promotions in the same group shares similar characteristics such as offering similar types of rewards, and having similar limitations.

Promotion Policy: abstraction of business policies that govern the applicability and combinability of promotions.

Priority: the importance of promotions, usually determines the order in which two otherwise equal promotions should be attempted, and
Invocation template: a preconfigured set of a number of promotion groups in a given order. Callers of a promotion system will specify an invocation template to use, and the system will identify the list of promotions within the set to attempt.

Conflict resolution: determine a relationship between a plurality of situations with constraints and select a solution.

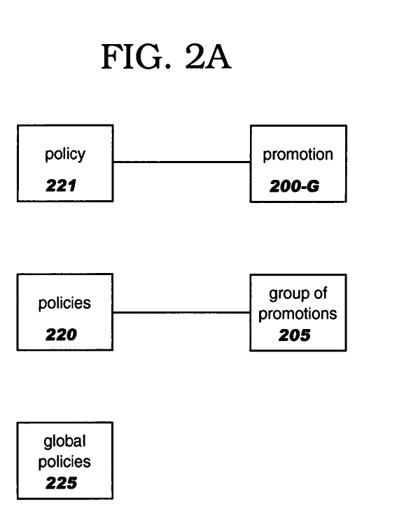

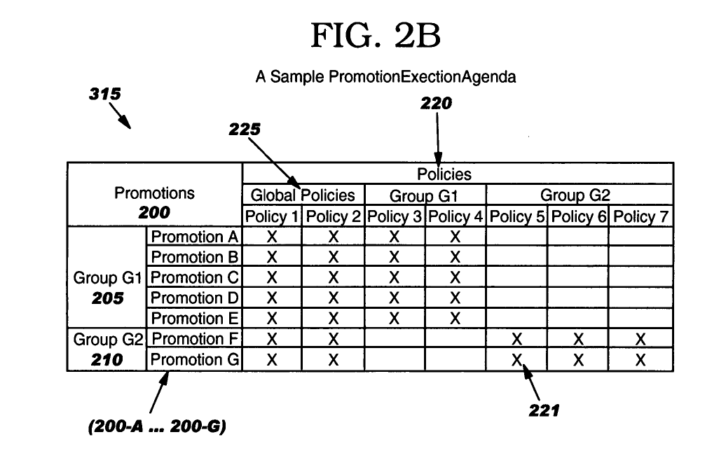

Referring to FIG. 2A, three examples of promotion and policy relationships may be seen. The first example shows policy 221 being directly related to promotion 200-G (if policy 5 as shown in FIG. 2B had only one match with promotions 200). Next is shown policies 220 related with promotions group 205. And finally global policy 225 is shown in isolation not directly related to a particular one promotion or group of promotions as global policies are applicable to all promotions.

Referring to FIG. 2B, the process begins with the creation of promotions 200 and assignment to promotion group 205 or 210. Promotion groups 205 and 210 are associated promotion policies 220. The fact a promotion 200 is a member of a promotion group 205 implies that promotion 200 is governed by all the promotion policies 220 associated with the group. Promotion policies 220 can also be associated with no group at all. In that case, the specific policy 220 is applicable to all promotions in the system as in the case of global policies 225. When it is time to evaluate which are the applicable promotions 200, the caller will specify an invocation template (not shown). The Invocation template is then passed to a component of the promotion system called PromotionExecutionAgendaBuilder 305 (of FIG. 3) which builds a table 315 that looks like the following based on the invocation template and promotion organizations.

Table 315 is referred to as a Promotion Execution Agenda. It provides the specification of the list of promotions that should be attempted during this invocation, and the policies that should be applied to each one of them in the stylized form of a relationship table. As in the sample above, promotions 200 in two groups “Group G1” 205 and “Group G2” 210 need to be attempted in this invocation. That includes promotion 200-A through 200-G. Because policies “Policy 1” and “Policy 2” are part of global policies 225, they are applicable to promotion 200-A through 200-G. Because promotion 200-A through 200-E are members of promotion Group “G1” 205, and policies 3 and 4 are associated with group G1 205, they are applicable to promotion 200-A through 200-E. Similarly promotion policies 5 through 7 are applicable to promotion 200-F and 200-G

Table 315 is a result of a call to a buildAgenda method of configurable component PromotionExecutionAgendaBuilder 305 of FIG. 3. A design pattern called “Builder” was employed to externalize the logic that actually builds table 315 of FIG. 2. While a table has been shown it may be appreciated that other suitable means may also be employed such as arrays, sets of vectors, graphs or lists to contain elements and the relationships.

Referring now to FIG. 3, may be seen a class diagram of PromotionEngine 300 showing the pattern for the case of building promotion and policy relationship table called an agenda and the case of building a promotion sequence list. It is the concrete builder's responsibility to build the agenda, meaning table 315. The behavior described earlier in this section is the behavior of the DefaultPromotionExeuctionAgendaBuilder 310, an important mechanism. DefaultPromotionExeuctionAgendaBuilder 310 externalizes the logic to build an agenda and makes it possible for others to customize and extend the behavior of the system.

Once the agenda (represented by table 315) is built, the next step is to determine in which order these promotions will be evaluated. This sequence of evaluation is determined by a call to another configuration component called PromotionExecutionSequenceBuilder 325 as seen in the class diagram of FIG. 3. Here again, a builder pattern is employed to externalize the logic that determines the evaluation sequence or list.

The simple behavior of DefaultSequenceBuilder 330 may be described as follows: if promotion A and promotion B are in different promotion groups, and promotion group A precedes promotion group B in the invocation template, promotion A will be attempted before promotion B. If promotion A and promotion B are in the same group, and if promotion A has a higher priority than promotion B, promotion A will be evaluated ahead of promotion B. When promotion A and B are in the same group and have the same priority, the sequence will be determined at random. This builder pattern makes it possible for the system to be customized or extended. For example, in a system where a “promotion code” may be used, it is usually simple to swap in an implementation of a sequence builder that inherits all the behavior of the default builder but observes one more rule: promotion for which a “code” is entered will be evaluated before promotions for which no “code” is entered.

The list of promotions 200 that need to be attempted and the order in which they should be attempted are now determined from PromotionExecutionSequenceBuilder 325. Sequence vector 335 provides a listing of the sequence in which the promotions should be attempted. Sequence vector 335 may not include all of the references as some promotions may have been excluded from the build request. Customization can be used to provide the desired sequence list based on predetermined needs. The system then proceeds to evaluate promotions 200 one by one and applies promotion policies 220 in doing so as shown in FIG. 4.

Referring to FIG. 4, for each promotion 200 listed in the sequence obtained from PromotionExecutionSequenceBuilder 325, the system will evaluate the conditions associated with the promotion. Beginning with operation 400 the evaluation process commences and moves to operation 410 during which is determined the existence of more promotions to evaluate. Evaluation of promotions establishes whether the conditions or constraints of the promotion have been satisfied one or more times. If the conditions have been satisfied more than once, then a promotion execution record is created. The promotion execution record (which may be described as a vector containing promotion entries) will then be tentatively applied to the respective purchase item or object during operation 450. Upon creation of a promotion execution record applicability of promotions contained within are then known. If it is indicated that there are no more promotions to apply processing will then move to end at operation 500. If the conditions are satisfied, the system will obtain the next promotion during operation 420 then move to operation 430 during which the promotion is evaluated. The process then determines during operation 440 the applicability of the promotion evaluated during operation 430. If not applicable, processing returns to operation 410, otherwise proceeds to operation 450. During operation 450 all policies applicable to the promotion are obtained using table 315. It will then apply the list of policies indicated, one by one to the promotion cycling through operations 460, then 470 and 480. In the process, if a violation of any policy is detected during operation 480, the promotion is deemed not applicable, and will be eliminated and processing would then move back to operation 410 and continue as described before. If no violation is detected during operation 480 after all indicated policies are applied, the promotion would then be applied during operation 490, after which processing would move to end at operation 500.

The focal point of this process is promotion policies 220. A standard interface for all promotion policies is implemented, such as the ones that enforce the number of times a promotion can be applied and whether a promotion can be combined with another promotion. Using this simple yet effective design technique, flexibility needed to introduce new promotion policies 220 and/or changes to existing policies 220 may be more easily obtained.

Referring now to FIG. 5 is shown an overall view of the conflict resolution process starting with having now created the table relating promotions and policies during operation 600 as has been described in conjunction FIG. 5, a context object is created during operation 605 to capture objects defined by table 315. During operation 606 begins the actual “transaction” portion, and then during operation 610, is created a control object which is initialized with the clones of objects from the context object created during operation 615. This control object serves the same purpose as the log in a RDBMS. Any changes that result from applying a promotion during operation 620 are applied to the control object. The control object then represents the “after state” of the system, while the context object represents the “before state” of the system. Policies 220 work with the control object only, which presents policies 220 with a view of the system “after state”. A determination is made regarding more policies 220 to apply during operation 625. If more policies 220 are to be applied they are then applied during operation 635 otherwise processing moves to operation 630 in which the changes are committed after which the process ends at operation 645. If more policies are detected during operation 625, processing would move to operation 635 as indicated earlier during which policies 220 would have been applied. Having applied policies 220, processing would move to operation 640 during which a determination would be made regarding any possible violations of policies 220. If violations were determined then processing would move to end at operation 645. If no violations were determined then processing would move to operation 625 again with processing to continue as described. When a violation is detected during operation 640, the control object is then simply discarded and the system remains in the “before state” because the context object has not changed at all. This state then represents a “rollback” operation in the analogy of the RDBMS. If there was no violation detected during operation 640, the system would retrieve the objects from the control object and replace those in the context object with the retrieved ones during “transaction commit” operation 620, again using the RDBMS analogy.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

1. A computer implemented method for providing transaction oriented conflict resolution for an electronic commerce application, the computer implemented method comprising:
obtaining one or more promotions each having at least one associated policy;
creating a context object containing a plurality of objects indicative of an initial state;
creating a control object containing clones of the plurality of objects contained within the context object;
applying the one or more promotions to the control object;
checking for violation of the at least one policy associated with the respective one or more promotions and where none is found committing the promotion; otherwise rolling back to a state indicated by the context object and ending the transaction.

2. The computer implemented method of claim 1, further comprising obtaining one or more promotions each having at least one associated policy prior to creation of a Promotion Execution Agenda.

3. The computer implemented method of claim 1, wherein the step of committing the promotion comprises retrieving the plurality of objects from the control object and replacing those in the context object with the retrieved objects.

4. The computer implemented method of claim 1, wherein the rolling back step comprises discarding the control object to restore a system state to the initial state.

5. A computer system for providing transaction oriented conflict resolution for an electronic commerce application, the computer system comprising:
means for obtaining one or more promotions each having at least one associated policy;
means for creating a context object containing a plurality of objects indicative of an initial state;
means for creating a control object containing clones of the plurality of objects contained within the context object;
means for applying the one or more promotions to the control object;
means for checking for violation of the at least one policy associated with the respective one or more promotions and where none is found committing the promotion; otherwise rolling back to a state indicated by the context object and ending the transaction.

6. The computer system of claim 5, further comprising means for obtaining one or more promotions each having at least one associated policy prior to creation of a Promotion Execution Agenda.

7. The computer system of claim 5, wherein the committing the promotion, of the means for checking for violation, comprises retrieving the plurality of objects from the control object and replacing those in the context object with the retrieved objects.

8. The computer system of claim 5, wherein the rolling back, of the means for checking violation, comprises discarding the control object to restore a system state to the initial state.

9. An article of manufacture for directing a data processing system to provide transaction oriented conflict resolution for an electronic commerce application, the article of manufacture comprising:
a computer usable medium embodying one or more instructions executable by the data processing system, the one or more instructions comprising:
data processing system executable instructions for obtaining one or more promotions each having at least one associated policy;
data processing system executable instructions for creating a context object containing a plurality of objects indicative of an initial state;
data processing system executable instructions for creating a control object containing clones of the plurality of objects contained within the context object;
data processing system executable instructions for applying the one or more promotions to the control object;
data processing system executable instructions for checking for violation of the at least one policy associated with the respective one or more promotions and where none is found committing the promotion; otherwise rolling back to a state indicated by the context object and ending the transaction.

10. The article of manufacture of claim 9, further comprising data processing system executable instructions for obtaining one or more promotions each having at least one associated policy prior to creation of a Promotion Execution Agenda.

11. The article of manufacture of claim 9, wherein the committing the promotion, of checking for violation, comprises data processing system executable instructions for retrieving the plurality of objects from the control object and replacing those in the context object with the retrieved objects.

12. The article of manufacture of claim 9, wherein the rolling back, of for checking violation, comprises data processing system executable instructions for discarding the control object to restore a system state to the initial state.
